(19) United States
(12) Patent Application Publication
(10) Pub. No.: US 2018/0266530 A1
(43) Pub. Date: Sep. 20, 2018

(54) ELECTRO-MECHANICAL LINEAR ACTUATOR

(71) Applicants: Don Alfano, Roscoe, IL (US); Greg Nichols, Crystal Lake, IL (US)

(72) Inventors: Don Alfano, Roscoe, IL (US); Greg Nichols, Crystal Lake, IL (US)

(21) Appl. No.: 15/921,732

(22) Filed: Mar. 15, 2018

Related U.S. Application Data
(60) Provisional application No. 62/471,823, filed on Mar. 15, 2017.

(51) Int. Cl. F16H 25/20; F16H 57/029; H01R 12/58; H01R 12/71; H01R 13/52; H02K 5/22; H02K 7/116; H02K 11/215

(52) U.S. Cl. CPC F16H 25/2015; F16H 57/029; H01R 12/58; H01R 12/716; H01R 13/5202; F16H 2057/02034; H02K 7/116; H02K 11/215; F16H 2025/2081; F16H 2025/2031; H02K 5/225

(57) ABSTRACT

An electro-mechanical linear actuator is provided and includes a housing. A motor is supported within the housing and includes an output shaft. A gear package includes a drive package. The gear package is configured to engage the motor such that rotation of the output shaft provides rotation of the gear package. A lead screw engages the gear package such that rotation of the gear package provides rotation of the lead screw. A nut assembly engages the lead screw such that rotation of the output shaft causes axial travel of the nut assembly. A drag link is coupled to the nut assembly such as to provide axial travel of the drag link. An electrical connector is formed as a single unitary body with the housing and is configured to receive an electrical connector in electrical communication with an external controller.

### CROSS-REFERENCE TO RELATED APPLICATIONS

This application claims the benefit of U.S. Provisional Application No. 62/471,823 filed Mar. 15, 2017, the disclosure of which is incorporated herein by reference.

### BACKGROUND

An electro-mechanical linear actuator is a device that is used to cause axial movement of a workpiece along a desired path. A typical electro-mechanical linear actuator includes an electric motor having a rotatable output shaft. The output shaft of the electric motor is connected through a gear train to a leadscrew mechanism and an engaged nut assembly. The engaged nut assembly can have various forms including the non-limiting examples of a ball nut or a sliding nut. Rotation of the output shaft of the electric motor causes corresponding rotation of the leadscrew. The engaged nut assembly has an opening formed therethrough having an internal thread. The leadscrew extends through the opening and has an external thread formed thereon that cooperates with the internal thread formed on the engaged nut assembly. The engaged nut assembly is mounted on the leadscrew in such a manner as to be restrained from rotating with the leadscrew when the leadscrew rotates. As a result, rotation of the leadscrew causes linear movement of the engaged nut assembly axially along the leadscrew. The direction of such axial movement of the engaged nut assembly (and the workpiece connected thereto) is dependent upon the direction of rotation of the leadscrew.

Electro-mechanical linear actuators are widely used in a variety of applications ranging from small to heavy loads. To meet the task at hand, electro-mechanical linear actuators come in all sizes; generally with larger, heavier electro-mechanical linear actuators handling large loads, and smaller, lighter electro-mechanical linear actuators handling small loads.

Regardless of their size, electro-mechanical linear actuators can include wiring and feedback systems, thereby enabling control of the electro-mechanical linear actuator. Conventional wiring and feedback systems can be complex, large, and difficult to install.

In certain instances, the feedback system needs to fit within the restrictive envelope of the electro-mechanical linear actuator, thereby increasing the necessary size of the housing included in the electro-mechanical linear actuator.

It would be desirable to provide an improved electro-mechanical linear actuator, with simplified wiring and an enhanced feedback system, thereby reducing the overall footprint required for the electro-mechanical linear actuator and simplifying installation.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the electro-mechanical linear actuator.

The above objects as well as other objects not specifically enumerated are achieved by an electro-mechanical linear actuator. The electro-mechanical linear actuator includes a housing formed by a first housing attached to a second housing. A motor is supported within the first and second housings, the motor including a rotatable output shaft. A gear package includes a drive package and a sensor package. The gear package is configured to engage the output shaft of the motor such that rotation of the output shaft results in rotation of portions of the gear package. A lead screw is configured to engage the gear package such that rotation of portions of the gear package results in rotation of the lead screw. The lead screw has an external thread. A nut assembly is configured to cooperate with the external thread of the lead screw such that rotation of the output shaft of the motor causes travel in an axial direction of the nut assembly. A drag link is coupled to the nut assembly such that travel in an axial direction of the nut assembly causes corresponding travel in an axial direction of the drag link. An electrical connector housing is formed as a single, unitary body with the housing and is configured to receive an electrical connector in electrical communication with an external controller.

The above objects as well as other objects not specifically enumerated are also achieved by an electro-mechanical linear actuator. The electro-mechanical linear actuator includes a housing formed by a first housing attached to a second housing. A motor is supported within the first and second housings. The motor includes a rotatable output shaft. A gear package includes a drive package and a sensor package. The gear package is configured to engage the output shaft of the motor such that rotation of the output shaft results in rotation of portions of the gear package. A lead screw is configured to engage the gear package such that rotation of portions of the gear package results in rotation of the lead screw. The lead screw has an external thread. A nut assembly is configured to cooperate with the external thread of the lead screw such that rotation of the output shaft of the motor causes travel in an axial direction of the nut assembly. A drag link is coupled to the nut assembly such that travel in an axial direction of the nut assembly causes corresponding travel in an axial direction of the drag link. A feedback system is configured to radially position a magnet with respect to a sensor, wherein the sensor package is configured to limit a range of rotation of the magnet to one turn of 360 degrees.

Various aspects of the electro-mechanical linear actuator will become apparent to those skilled in the art from the following detailed description of the illustrated embodiments, when read in light of the accompanying drawings.

### BRIEF DESCRIPTION OF THE DRAWINGS

FIG. 1 is a perspective view of an electro-mechanical linear actuator.

FIG. 2 is an exploded perspective view of a portion of the electro-mechanical linear actuator of FIG. 1.

FIG. 3 is an exploded perspective view of a portion of the electro-mechanical linear actuator of FIG. 1.

FIG. 4 is an exploded perspective view of a portion of the electro-mechanical linear actuator of FIG. 1.

FIG. 5 is a partial cross-sectional view of a portion of the electro-mechanical linear actuator of FIG. 1.

FIG. 6 is a perspective view of a portion of the electro-mechanical linear actuator of FIG. 1 illustrating a connector housing and an electrical connector.

FIG. 7 is a perspective view of a feedback system included in the electro-mechanical linear actuator of FIG. 1.

### DETAILED DESCRIPTION

The electro-mechanical linear actuator will now be described with occasional reference to specific embodiments. The electro-mechanical linear actuator may, however, be embodied in different forms and should not be construed as limited to the embodiments set forth herein. Rather, these embodiments are provided so that this disclosure will be thorough and complete, and will fully convey the scope of the electro-mechanical linear actuator to those skilled in the art.

Unless otherwise defined, all technical and scientific terms used herein have the same meaning as commonly understood by one of ordinary skill in the art to which the electro-mechanical linear actuator belongs. The terminology used in the description of the electro-mechanical linear actuator is for describing particular embodiments only and is not intended to be limiting of the electro-mechanical linear actuator. As used in the description of the electro-mechanical linear actuator and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in the embodiments of the electro-mechanical linear actuator. Notwithstanding that the numerical ranges and parameters setting forth the broad scope of the electro-mechanical linear actuator are approximations, the numerical values set forth in the specific examples are reported as precisely as possible. Any numerical values, however, inherently contain certain errors necessarily resulting from error found in their respective measurements.

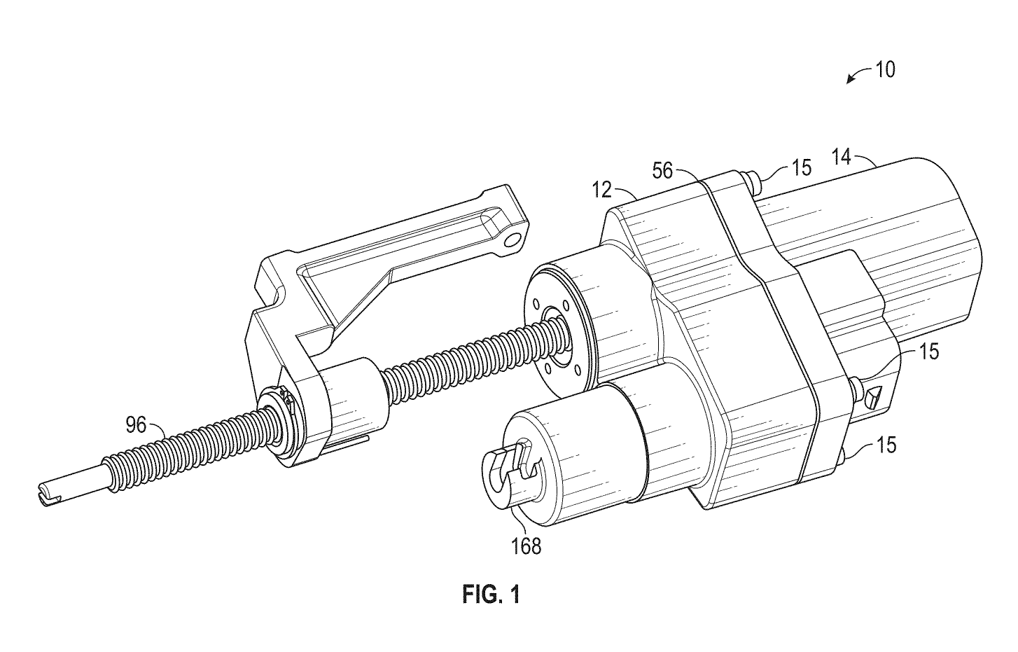

Referring now to the figures, there is illustrated in FIG. 1 an electro-mechanical linear actuator 10 (hereafter “linear actuator”). Generally, the linear actuator 10 is cost effective, suitable for use in applications where space is limited, configured to receive an electrical current input and provide an axial output.

Referring again to FIG. 1, the linear actuator 10 includes a plurality of housings, each of which defines internal regions. The linear actuator 10 includes a first housing 12 and a second housing 14. The first and second housings 12 and 14 are configured to support various internal components, as well as protect the various internal components from external conditions. The first and second housings 12 and 14 are connected together via a plurality of threaded fasteners 15. In the illustrated embodiment, the threaded fasteners 15 are socket head cap screws configured to extend through apertures in the second housing 14 and into corresponding threaded apertures in the first housing 12. In other embodiments, the first and second housings 12 and 14 can be connected together with other structures, mechanisms or devices.

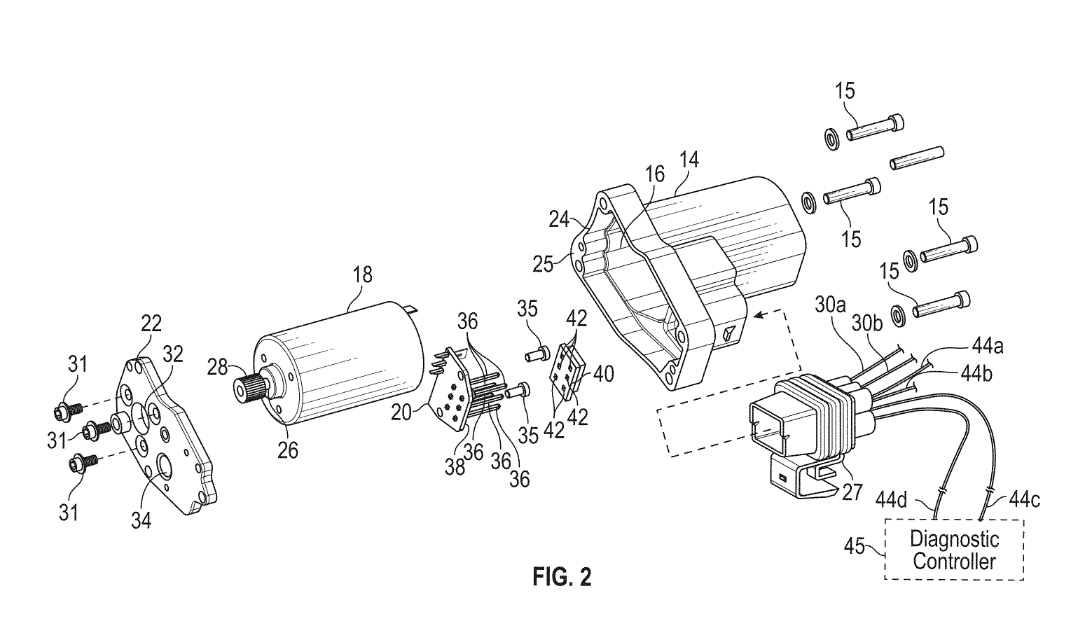

Referring now to FIG. 2, an exploded view of a portion of the linear actuator 10 is illustrated. The second housing 14 has a cavity 16 formed therein. The cavity 16 is configured to receive a motor 18, a circuit board 20, and a retaining member 22. The cavity 16 extends from an opening 24 disposed within a connecting face 25 of the second housing 14.

Referring again to FIG. 2, the motor 18 is connected to the retaining member 22 via a plurality of threaded fasteners 31. In the illustrated embodiment, the threaded fasteners 31 are socket head cap screws configured to extend through apertures in the retaining member 22 and into corresponding threaded apertures in the motor 18. In other embodiments, the motor 18 can be connected to the retaining member 22 with other structures, mechanisms or devices.

Referring again to FIG. 2, the motor 18 includes an outboard motor shaft 26 and a motor gear 28 connected thereto. The motor 18 is configured to rotate the outboard motor shaft 26 in response to a provided electrical current input.

Referring again to FIG. 2, the opening 24 of the cavity 16 is defined by a perimeter having a shape that corresponds to the shape of the perimeter of the retaining member 22. In the illustrated embodiment, the retaining member 22 is located to the second housing 14 with a combination of dowels and threaded fasteners (not shown for purposes of clarity). In other embodiments, other structures, mechanisms and devices can be used to locate the retaining member 22 to the second housing 14.

Referring again to FIG. 2, the retaining member 22 includes a first opening 32 and a second opening 34, both formed therethrough. The first opening 32 is configured to permit the motor gear 28 to extend therethrough without engagement. The second opening 34 will be discussed further below.

Referring again to FIG. 2, the circuit board 20 is connected to the retaining member 22 via a plurality of threaded fasteners 35. In the illustrated embodiment, the threaded fasteners 35 are socket head cap screws configured to extend through apertures in the circuit board 20 and into corresponding threaded apertures in the retaining member 22. In other embodiments, the circuit board 20 can be connected to the retaining member 22 with other structures, mechanisms or devices.

Referring again to FIG. 2, the circuit board 20 includes a plurality of extending pins 36 and an integrated circuit 38. A circuit board seal member 40 includes a plurality of receptacles 42 substantially aligned with the plurality of pins 36 and configured to receive the plurality of pins 36. The pins 36 extend through the circuit board seal member 40 and electrically connect to an individual wire of the group 30a and 30b and 44a-44d. The wires 30a and 30b are configured to provide an electrical current input for the motor 18. Wires 44a and 44b are configured to provide electrical power for the integrated circuit 38. Wires 44c and 44d are configured to transmit a first feedback signal and a redundant feedback signal from the integrated circuit 38 to a diagnostic controller, shown schematically at 45. Although illustrated as using wires 44c and 44d to transmit feedback signals, it should be appreciated that the linear actuator 10 may include other mechanisms, structures or devices sufficient to transmit feedback signals, including the non-limiting example of wireless transmission. Additionally, although illustrated as using wires 44a, 44b, 30a and 30b to provide electrical power, it should be appreciated that the linear actuator 10 may include other mechanisms, structures or devices sufficient to provide electrical power, including the non-limiting example of wireless transmission.

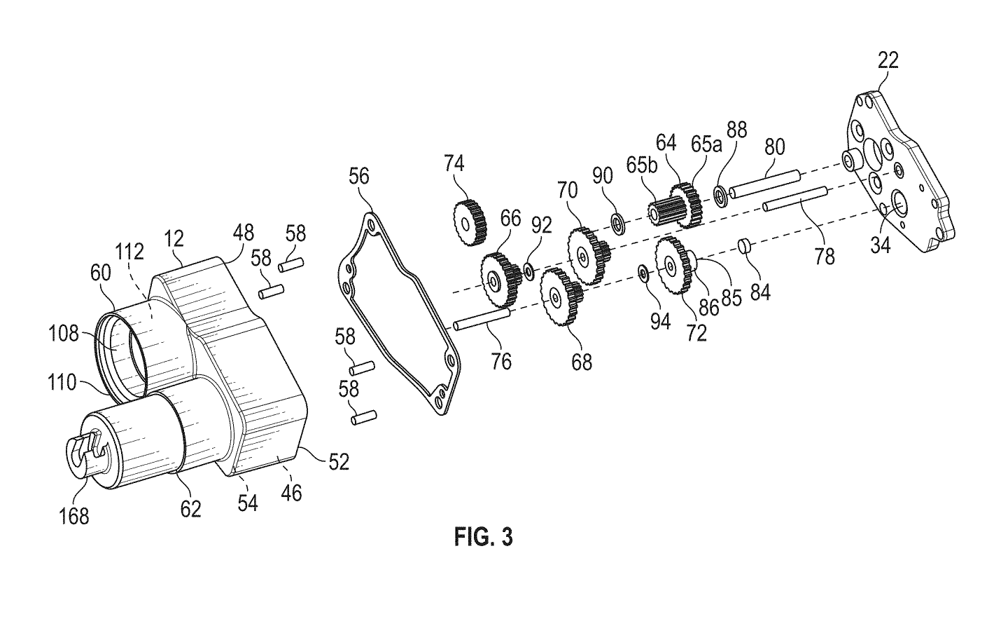

Referring now to FIG. 3, an exploded view of a portion of the linear actuator 10 is illustrated. The first housing 12 has a cavity 46 formed therein and configured to cooperate with the cavity 16 to enclose and support a gear package 50. The cavity 46 extends from an opening 52 disposed within a connecting face 48 of the first housing 12 to a wall 54. The wall 54 includes a plurality of bosses (not shown) configured to support the gear package 50.

Referring now to FIGS. 1 and 3, a gasket 56 is configured to provide a seal between the first housing 12 and the second housing 14. The gasket 56 has a shape that corresponds to the perimeters of connecting faces 25 and 48, which are located on the second housing 14 and the first housing 12 respectively. The gasket 56 is assembled to the connecting face 48 of the first housing 12 and held in place via a pair of locating pins 58. When the first housing 12 and the second housing 14 are assembled, the gasket 56 compresses between the connecting faces 25 and 48, thereby forming a seal therebetween. In the illustrated embodiment, the gasket 56 is formed from a polymeric material with compression features, such as the non-limiting examples of polyurethane or polypropylene. However, it should be appreciated that the gasket 56 could be made out of any suitable material, or combinations of materials, sufficient to provide a seal between the first housing 12 and the second housing 14. While the illustrated embodiment shows the gasket 56 as the sealing structure, it should be appreciated that the linear actuator 10 can include other mechanisms, structures or devices sufficient to provide a seal between the first housing 12 and the second housing 14.

Referring now to FIG. 3, the front housing 12 includes a first boss 60 and a second boss 62. A cavity 108 is formed within the first boss 60. The cavity 108 extends from an opening 110 to the wall 54. The wall 54 includes an opening 112 formed therethrough. The first and second bosses 60 and 62 will be discussed in more detail below.

Referring again to FIG. 3, the gear package 50 is illustrated in an exploded arrangement. As will be explained in more detail below, the gear package 50 is configured to transfer torque from the motor 18 to a leadscrew assembly and a feedback system.

Referring again to FIG. 3, the gear package 50 includes compound gears 64, 66, 68 and 70, a drive gear 74 and a sensor gear 72. The compound gear 64 is representative of the compound gears 66, 68 and 70. The compound gear 64 includes a first gear 65a and a second gear 65b. The first gear 65a is driven by the motor gear 28 and has a circumference that is larger than the circumference of the second gear 65b, thus resulting in a torque increase and a rotational speed decrease.

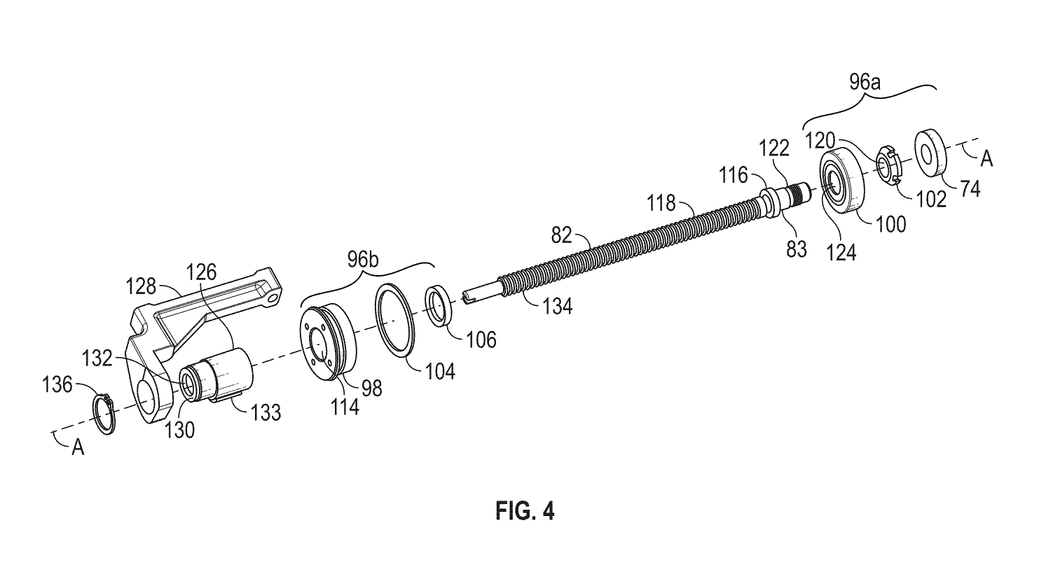

Referring again to FIG. 3, gear axles 76, 78 and 80, are configured to support the compound gears 64, 66, 68 and 70 and the sensor gear 72 for rotation. The drive gear 74 is supported by a ball-type leadscrew 82 (hereafter “leadscrew”) (see FIG. 4), which will be discussed further below. The gear axles 78 and 80 extend from the retaining member 22 to the wall 54 that bounds the cavity 46 of the first housing 12. The gear axle 76 has a cantilevered orientation and extends from the wall 54 into the cavity 46.

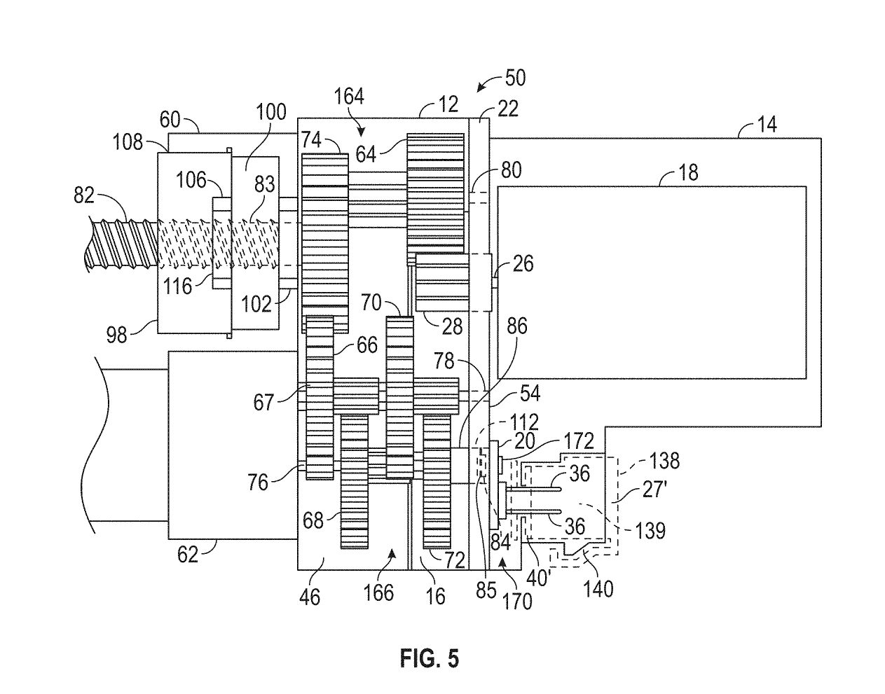

Referring again to FIG. 3, the sensor gear 72 includes a hub 86. The hub 86 is configured to extend through the opening 34 of the retaining member 22. The hub 86 includes a recess 85 formed therein. The recess 85 is configured to receive a magnet 84. The magnet 84, positioned within the recess 85 on the hub 86, is located in proximity to the circuit board 20 and the integrated circuit 38, as shown in FIG. 5.

Referring again to FIG. 3, spacers 88 and 90 are disposed on gear axle 80 on opposite sides of the compound gear 64. Spacer 92 is disposed on gear axle 78 in-between compound gears 66 and 70. Finally, spacer 94 is disposed on gear axle 76 in-between compound gear 68 and sensor gear 72. The spacers 88, 90, 92 and 94 are configured to provide substantially frictionless surfaces to facilitate rotation of the compound gears 64, 66, 68, 70 and sensor gear 72. Operation of the gear package 50 will be described in more detail below.

Referring now to FIG. 4, an exploded view of a first support assembly 96a and a second support assembly 96b is illustrated. Generally, the first and second support assemblies 96a and 96b are configured to support an inboard portion of the leadscrew 82. The support assembly 96a includes a bearing 100 and a bearing lock nut 102. The support assembly 96b includes a retaining nut 98, o-ring 104 and a shaft seal 106.

Referring now to FIGS. 3, 4 and 5, the first and second support assemblies 96a and 96b are disposed within the cavity 108 formed within the first boss 60. The opening 112 within the wall 54 is configured to permit a lead screw journal 83 of the leadscrew 82 to extend through the cavity 108 and engage the first and second support assemblies 96a and 96b and the drive gear 74 located within the cavity 46.

Referring again to FIGS. 3 and 4, the retaining nut 98 is configured to retain the lead screw journal 83 of the leadscrew 82 within the cavity 108. The retaining nut 98 is received within the cavity 108 and connected to the first housing 12 by a mating thread (not shown). The retaining nut 98 includes an opening 114 formed therethrough. The opening 114 has a diameter that is greater than a diameter of a first threaded portion 118 of the leadscrew 82, thereby allowing the first threaded portion 118 of the leadscrew 82 to pass through. The first support assembly 96a is inserted into the cavity 108. In that position, the bearing 100 is supported by a shoulder (not shown) and the retaining nut 98 is configured to retain the bearing 100 within the cavity 108 by the mating thread.

Referring now to FIG. 4, the lock nut 102 is configured to substantially prevent axial movement of the ball bearing 110 on the leadscrew journal 83 against a shoulder 116. The lock nut 102 includes an opening 120 formed therethrough having a circumferential threaded surface. The circumferential threaded surface of the lock nut 102 is configured to threadably engage a second threaded portion 122 of the leadscrew 82. In operation, retaining nut 98 traps bearing 100 in cavity 108 of first boss 60 in housing 12, thereby substantially preventing further axial movement of the leadscrew 82 within the support assembly 96.

Referring now to FIGS. 3 and 4, the bearing 100 is configured to radially support the leadscrew 82, and maintain the leadscrew 82 in an orientation along an axis A-A. The shaft seal 106 is configured to provide a seal with the shoulder 116 on the leadscrew 82. The shaft seal 106 may be made out of a polymeric material, or a combination of polymeric materials, with compression features, such as the non-limiting examples of polyurethane or polypropylene. However, it should be appreciated that the shaft seal 106 could be made out of any suitable material, or combinations of materials, sufficient to provide a seal.

Referring now to FIGS. 3-4, the o-ring 104 is configured to provide a seal between the retaining nut 98 and an inner wall of the cavity 108 of the first boss 60. With the retaining nut 98 assembled within the cavity 108, the o-ring 104 compresses, thereby creating a seal between the retaining nut 98 and the inner wall of the cavity 108 of the first boss 60. The o-ring 104 may be made out of a polymeric material, or a combination of polymeric materials, with compression features, such as the non-limiting examples of polyurethane or polypropylene. However, it should be appreciated that the o-ring 104 could be made out of any suitable material, or combinations of materials, sufficient to provide a sufficient seal between the retaining nut 98 and the inner wall of the cavity 108 of the first boss 60.

Referring now to FIG. 4, a nut assembly 126 and a drag link 128 are illustrated. In the illustrated embodiment, the nut assembly 126 has the form of a ball nut. However, in other embodiment, the nut assembly 126 can have other forms, such as for example, the non-limiting example of a sliding nut. The nut assembly 126 includes an opening 130 formed therethrough, defined by an inner circumferential wall 132. The inner circumferential wall 132 includes threads configured to engage a threaded outer circumferential surface 134 of the leadscrew 82 through a plurality of balls (not shown). The nut assembly 126 includes a ball return tube (not shown) which is held in position by clamp 133. Retention of the drag link 128 provides an anti-rotation feature to resist rotation when the leadscrew 82 rotates, thereby resulting in the nut assembly 126 traveling axially along the leadscrew 82 upon rotation of the leadscrew 82. By traveling axially along the leadscrew 82 as the lead screw 82 rotates, the nut assembly 126 converts the rotational torque of the leadscrew 82 into linear thrust of the nut assembly 126. It should be appreciated that the nut assembly 126 and the leadscrew 82 can include threads as described above, however in other embodiments, the nut assembly 126 and lead screw 82 can include other structures, mechanisms, or devices sufficient for engagement, such as the non-limiting example of races with balls, and any structures inherent to the other systems.

Referring again to FIG. 4, the drag link 128 is configured to transmit linear thrust from the nut assembly 126 to one or more downstream applications. In the illustrated embodiment, the drag link 128 is connected to the nut assembly 126 with mating threads on both the nut assembly 126 and the drag link 128, and with a redundant retention feature using a retaining ring 136. However, in other embodiments the drag link 128 can be connected to the nut assembly 126 in other desired manners sufficient to allow the drag link 128 to transmit linear thrust from the nut assembly 126 to one or more downstream applications downstream applications.

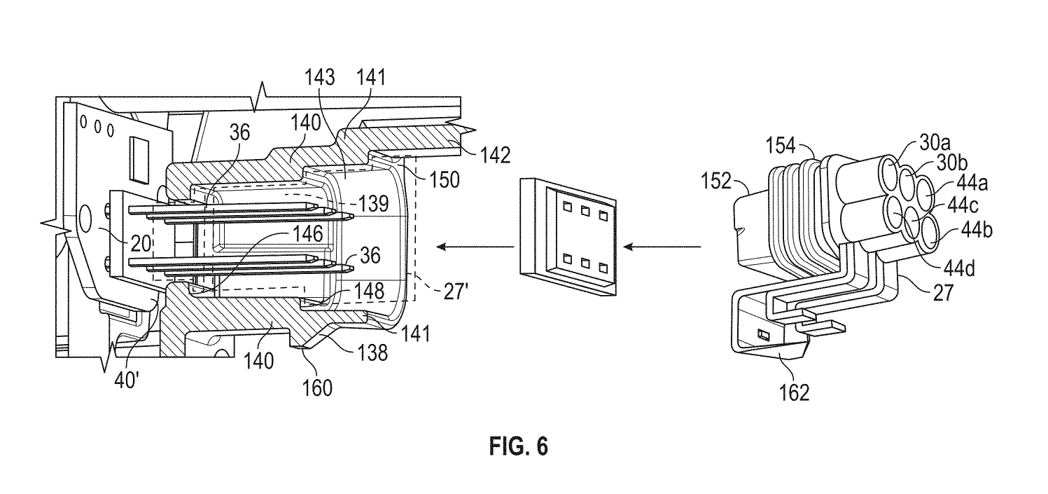

Referring now to FIG. 5, a partial cross-sectional view of the linear actuator 10 is illustrated. The linear actuator includes the first housing 12 and the second housing 14. The retaining member 22 includes the circuit board 20 and the plurality of pins 36 extending therefrom. The pins 36 extend into a connector housing 138. The connector housing 138 is configured for several functions. First, the connector housing 138 is configured to receive the electrical connector 27, in a manner such that the wires 30a, 30b and 44a-44d (not shown in FIGS. 5 and 6 for purposes of clarity) are electrically connected to the plurality of pins 36 extending from the circuit board 20. Second, the connector housing 138 includes structures configured to provide an easy, snap-type of assembly without the need for special tools. The snap-type of assembly will be discussed in more detail below. Third, the electrical connector 27, circuit board seal member 40 and the connector housing 138 are configured to cooperate such as to provide a sealed electrical connection between the pins 36 and the various internal components of the linear actuator 10. Finally, the incorporation of the connector housing 138 into the second housing 14 enables a user to connect the wires 30a, 30b and 44a-44d to the circuit board 20 after the linear actuator 10 has been installed in an application, thereby advantageously simplifying assembly, providing flexibility for customization, and reducing costs.

Referring now to the embodiment illustrated in FIGS. 5 and 6, the connector housing 138 is formed as an integral part of the second housing 14, such that the second housing 14 and the connector housing 138 are a single, unitary body. However, in other embodiments, the connector housing 138 can be formed as a discrete element apart from the second housing 14 and the connector housing 138 and the second housing 14 can be joined together.

Referring again to FIGS. 5 and 6, the connector housing 138 includes a cavity 139 formed therein. The cavity 139 is configured to receive the plurality of pins 36 extending from the circuit board 20 and is configured to compress the circuit board seal member 40 in a position adjacent to the circuit board 20 (as shown in FIGS. 5 and 6 by reference character 40′). The cavity 139 is further configured to receive the electrical connector 27. In the embodiment illustrated in FIGS. 5 and 6, the cavity 139 is defined by first circumferential walls 140, second circumferential walls 141 and third circumferential walls 142 forming a plurality of steps 146, 148 and 150. The first circumferential walls 140 of the connector housing 138 correspond to first exterior walls 152 of the electrical connector 27 such as to form a close fit therebetween in an installed position. In a similar manner, the second circumferential walls 141 of the connector housing 138 correspond to exterior circumferential compressible member 154 of the electrical connector 27 such as to form a seal fit therebetween in an installed position.

Referring again to FIGS. 5 and 6, the connector housing 138 includes a tab 160. The tab 160 is configured to receive a corresponding hook-type projection 162 in a manner such as to secure the electrical connector 27 to the connector housing 138 (the installed electrical connector 27 is shown in FIGS. 5 and 6 by reference character 27′). In an installed position, the first cavity 139 of the connector housing 138 receives the first exterior walls 152 of the electrical connector 27 in a manner such that the plurality of pins 36 electrically engage wires connectors (not shown) disposed within the electrical connector 27. The engagement of the plurality of pins 36 with the wire connectors is configured to provide electrical communication between the wires 30a, 30b and 44a-44d and the circuit board 20. Further, in an installed position, the second cavity 143 of the connector housing 138 receives the exterior circumferential compressible member 154 of the electrical member 27 in a manner such as to seal the various components and connections within the connector housing 138. However, it should be appreciated that the connector housing 138 and the electrical connector 27 can have other mating structures sufficient for the functions described herein.

Referring now to FIG. 5, the gear package 50 is shown as assembled within the first housing 12 and second housing 14. The gear package 50 is configured to transfer torque from the motor 18 to the leadscrew 82 and to the magnet 84. The gear package 50 includes two sub-gear packages, namely the drive package 164 and the sensor package 166. The drive package 164 and the sensor package 166 are arranged such that the gear axles 76, 78 and 80 are in a substantially parallel arrangement configured to reduce the overall footprint required for the gear package 50, such that the linear actuator 10 may fit within a restrictive envelope.

Referring again to FIG. 5, the drive package 164 is configured to transfer torque from the motor 18 to the leadscrew 82. The drive gear package 164 includes motor gear 28, compound gear 64, and drive gear 74. In operation, the motor gear 28 is configured to engage the compound gear 64, thereby transferring torque from the motor gear 28 to the compound gear 64. The compound gear 64 is configured to engage the drive gear 74, thereby transferring torque from the compound gear 64 to the drive gear 74. The drive gear 74 is connected to the leadscrew 82, such that rotation of the drive gear 74 results in rotation of the leadscrew 82.

Referring again to FIG. 5, the sensor package 166 is configured to transfer torque from the drive gear 74 to the magnet 84. The sensor package 166 includes the compound gear 66, compound gear 68, compound gear 70 and sensor gear 72. In operation, the compound gear 66 is configured to engage the drive gear 74, thereby transferring torque from the drive gear 74 to the compound gear 66. The compound gear 66 is further configured to engage the compound gear 68, thereby transferring torque from the compound gear 66 to the compound gear 68. The compound gear 68 is configured to engage the compound gear 70, thereby transferring torque from the compound gear 68 to the compound gear 70. Next, the compound gear 70 is configured to engage the sensor gear 72, thereby transferring torque from the compound gear 70 to the sensor gear 72. Finally, the magnet 84 is positioned within the recess 85 on hub 86 of the sensor gear 72, such that rotation of the sensor gear 72 results in rotation of the magnet 84. While the gear package 50 is described above and shown in FIG. 5, it should be appreciated that the gear package 50 can include other mechanisms, structures or devices sufficient to perform the tasks described herein, including the non-limiting examples of more or less gears or different gears.

Referring again to FIG. 5, the sensor package 166 is further configured to limit the range of rotation of the magnet 84 to one turn of 360 degrees. In one embodiment, the sensor package 166 is configured to have a 36:1 rotation speed reduction from the rotation speed of an input side 67 of compound gear 66 to the rotation speed of the magnet 84. It should be appreciated that in other embodiments the sensor package 166 can include other combinations of speed reductions configured to meet other requirements.

Referring now to FIGS. 1 and 3, the second boss 62 is illustrated. The second boss 62 includes an optional connector 168 extending therefrom. The optional connector 168 is configured to connect to downstream applications as may be necessary. The optional connector 168 can have any desired structure sufficient to connect to downstream applications.

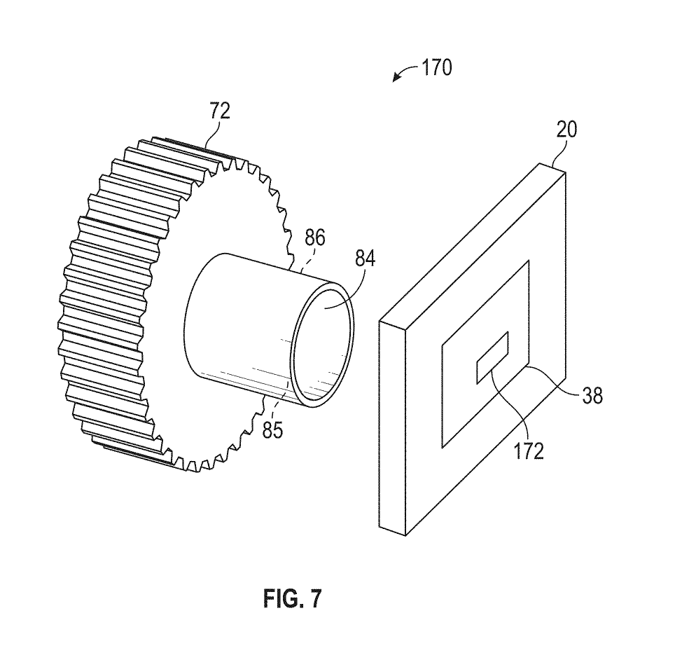

Referring now to FIGS. 5 and 7, a feedback system 170 and corresponding structures are illustrated. The feedback system 170 is configured to provide signals to the diagnostic controller 45 in order to provide a user with control and error detection abilities. The feedback system 170 includes the circuit board 20, the integrated circuit 38 and the magnet 84. The magnet 84 is positioned within a recess 85 of the hub 86 of the sensor gear 72, and is in proximity to the circuit board 20, and thus, the integrated circuit 38.

Referring again to FIGS. 5 and 7, the circuit board 20 includes a Hall effect sensor 172 incorporated into the integrated circuit 38. The Hall effect sensor 172 is configured to detect the rotational position of the magnet 84. The use of a Hall effect sensor 172 incorporated into the integrated circuit 38 on the circuit board 20 eliminates extraneous shafts, bearings, and housings that are typically associated with traditional feedback devices. Additionally, the Hall effect sensor 172 is disposed on the same circuit board 20 as the plurality of pins 36 for the motor and feedback connections, further simplifying assembly.

Referring again to FIGS. 5 and 7, the Hall effect sensor 172 is programmed at assembly to provide an analog output relating to the position of the magnet 84. As the magnet 84 rotates, the Hall effect sensor 172 detects different positional data from the magnet 84 at each radial position and generates discrete analog readings for each position. The Hall effect sensor 172 is further configured to transmit two signals, both the first feedback signal and the redundant feedback signal, via the wires 44c and 44d to a diagnostic controller 45.

The diagnostic controller 45 receives the first feedback signal and the redundant feedback signal. The diagnostic controller 45 is configured to analyze the first feedback signal and the redundant feedback signal and give a user the ability to ascertain operational errors and exercise more precise control of the linear actuator 10.

Referring now to FIG. 5, the operation of the linear actuator 10 will now be described in the following steps. In a first step, the motor 18 urges rotation of the motor shaft 26. In a next step, the motor shaft 26 rotates the motor gear 28. In a next step, the motor gear 28 engages the compound gear 64, thereby transferring torque from the motor gear 28 to the compound gear 64. Next, the compound gear 64 engages the drive gear 74, thereby transferring torque from the compound gear 64 to the drive gear 74. The drive gear 74 is attached to the leadscrew 82, such that rotation of the drive gear 74 results in rotation of the leadscrew 82.

Referring again to FIG. 5 in a next step, the drive gear 74 engages the compound gear 66, thereby transferring torque from the drive gear 74 to the compound gear 66. In a next step, the compound gear 66 engages the compound gear 68, thereby transferring torque from the compound gear 66 to the compound gear 68. Next, the compound gear 68 engages the compound gear 70, thereby transferring torque from the compound gear 68 to the compound gear 70. In a next step, the compound gear 70 engages the sensor gear 72, thereby transferring torque from the compound gear 70 to the sensor gear 72. In a further step, the sensor gear 72 is attached to the magnet 84, such that rotation of the sensor gear 72 results in rotation of the magnet 84.

Referring again to FIG. 5 in a next step, the Hall effect sensor 172 detects different positional signals per rotational position of the magnet 84. The Hall effect sensor 172 transmits a first feedback reading and a redundant feedback signal to the diagnostic controller 45. In a next step, the diagnostic controller 45 determines if an error has occurred in operation. One non-limiting example of a method to determine if an error has occurred is by comparing the first feedback signal and the redundant feedback signal. In a final step, upon a detection of the error occurring in operation, the diagnostic controller provides a user notification regarding the operation error. Additionally, the diagnostic 45 controller can alert the customer of the rotational position of the magnet 84, thereby resulting in more precise control abilities. As discussed above, the sensor package 166 is configured to limit the range of rotation of the magnet 84 to one turn of 360 degrees.

The principle and mode of operation of the electro-mechanical linear actuator have been explained and illustrated in certain embodiments. However, it should be understood that the electro-mechanical linear actuator may be practiced otherwise than as specifically explained and illustrated without departing from its spirit or scope.

What is claimed is:

1. An electro-mechanical linear actuator comprising:
a housing formed by a first housing attached to a second housing;
a motor supported within the first and second housings, the motor including a rotatable output shaft;
a gear package including drive package and a sensor package, the gear package configured to engage the output shaft of the motor such that rotation of the output shaft results in rotation of portions of the gear package;
a lead screw configured to engage the gear package such that rotation of portions of the gear package results in rotation of the lead screw, the lead screw having an external thread;
a nut assembly configured to cooperate with the external thread of the lead screw such that rotation of the output shaft of the motor causes travel in an axial direction of the nut assembly;
a drag link coupled to the nut assembly such that travel in an axial direction of the nut assembly causes corresponding travel in an axial direction of the drag link; and
an electrical connector housing formed as a single unitary body with the housing and configured to receive an electrical connector in electrical communication with an external controller.

2. The electro-mechanical linear actuator of claim 1, wherein the connector housing is formed as part of the second housing.

3. The electro-mechanical linear actuator of claim 1, wherein the connector housing extends in a direction away from the lead screw.

4. The electro-mechanical linear actuator of claim 1, wherein the connector housing defines a cavity configured to receive a plurality of pins extending from a circuit board.

5. The electro-mechanical linear actuator of claim 1, wherein the connector housing includes a plurality of circumferential walls disposed in a stepped arrangement.

6. The electro-mechanical linear actuator of claim 1, wherein a circuit board seal member is disposed between the control system and the electrical connector.

7. The electro-mechanical linear actuator of claim 1, wherein a plurality of power wires and feedback wires are coupled to the electrical connector.

8. The electro-mechanical linear actuator of claim 1, wherein in an installed position within the connector housing, the electrical connector forms a seal with the connector housing.

9. The electro-mechanical linear actuator of claim 1, wherein the connector housing includes a tab extending from an exterior wall.

10. The electro-mechanical linear actuator of claim 9, wherein the tab is configured to engage a hook-type projection extending from the electrical connector.

11. An electro-mechanical linear actuator comprising:
a housing formed by a first housing attached to a second housing;
a motor supported within the first and second housings, the motor including a rotatable output shaft;
a gear package including drive package and a sensor package, the gear package configured to engage the output shaft of the motor such that rotation of the output shaft results in rotation of portions of the gear package;
a lead screw configured to engage the drive package such that rotation of portions of the drive package results in rotation of the lead screw, the lead screw having an external thread;
a nut assembly configured to cooperate with the external thread of the lead screw such that rotation of the output shaft of the motor causes travel in an axial direction of the nut assembly;
a drag link coupled to the nut assembly such that travel in an axial direction of the nut assembly causes corresponding travel in an axial direction of the drag link; and
a feedback system configured to radially position a magnet with respect to a sensor, wherein the sensor package is configured to limit a range of rotation of the magnet to one turn of 360 degrees.

12. The electro-mechanical linear actuator of claim 11, wherein the sensor package of the gear package is configured to control rotation of the magnet.

13. The electro-mechanical linear actuator of claim 11, wherein the drive package of the gear package is configured to include a plurality of compound gears.

14. The electro-mechanical linear actuator of claim 11, wherein the sensor package includes a plurality of gear axles.

15. The electro-mechanical linear actuator of claim 11, wherein the drive package includes a plurality of gear axles configured to be substantially parallel to the plurality of gear axles included in the sensor package.

16. The electro-mechanical linear actuator of claim 11, wherein the sensor package includes a sensor gear having a hub with a recess.

17. The electro-mechanical linear actuator of claim 16, wherein the magnet is position in the recess of the hub.

18. The electro-mechanical linear actuator of claim 11, wherein the magnet is positioned adjacent a Hall effect sensor.

19. The electro-mechanical linear actuator of claim 11, wherein the Hall effect sensor is disposed on a circuit board.

20. The electro-mechanical linear actuator of claim 11, wherein the diagnostic controller is external to the electro-mechanical linear actuator.
